(19) United States
(12) Patent Application Publication
(10) Pub. No.: US 2026/0037189 A1
(43) Pub. Date: Feb. 5, 2026

(54) DIRECT ACCESS OF A DATASET IN A FABRIC-ATTACHED MEMORY FOR A DISTRIBUTED WORKFLOW

(71) Applicant: Micron Technology, Inc., Boise, ID (US)

(72) Inventors: Jacob M. JACOB, Cedar Park, TX (US); Katya GIANNIOS, West Lafayette, IN (US); Bambi DELAROSA, Frisco, TX (US); David A. ROBERTS, Wellesley, MA (US)

(21) Appl. No.: 18/790,752

(22) Filed: Jul. 31, 2024

(51) Int. Cl. G06F 3/06; G06F 13/42

(52) U.S. Cl. CPC G06F 3/067; G06F 3/061; G06F 3/0659; G06F 13/4221; G06F 2213/0026

(57) ABSTRACT

In some implementations, a memory system may store a dataset in a portion of a fabric-attached memory, wherein the dataset is stored in a format that enables zero-copy analysis of the dataset by multiple host devices associated with a distributed workflow. The memory system may establish a respective direct access connection to the portion of the fabric-attached memory with each host device of the multiple host devices associated with the distributed workflow. The memory system may permit each host device, of the multiple host devices, to access the dataset via the respective direct access connection and by using a zero-copy access technique to extract a batch of data objects from the dataset for performing a computation associated with the distributed workflow.

### TECHNICAL FIELD

The present disclosure generally relates to memory devices, memory device operations, and, for example, to direct access of a dataset in a fabric-attached memory for a distributed workflow.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIG. 1 is a diagram illustrating an example system associated with direct access of a dataset in a fabric-attached memory (FAM) for a distributed workflow.

FIG. 2 is a diagram illustrating another example system associated with direct access of a dataset in an FAM for a distributed workflow.

FIGS. 3A-3C are diagrams of examples associated with direct access of a dataset in an FAM for a distributed workflow.

FIG. 4 is a flowchart of an example method associated with direct access of a dataset in an FAM for a distributed workflow.

FIG. 5 is a flowchart of another example method associated with direct access of a dataset in an FAM for a distributed workflow.

### DETAILED DESCRIPTION

The field of machine learning (ML) is integral to a multitude of commercial applications ranging from drug discovery to predictive weather modeling. These ML applications require processing vast amounts of data to train sophisticated algorithms capable of solving complex problems. The capacity for data processing has become increasingly demanding as the volume of industry-scale datasets continues to exponentially grow.

The described implementations leverage advanced memory architecture and data handling techniques to enhance the technical scalability and efficiency of ML workflows in distributed computing environments. Specifically, a distributed workflow system capitalizes on a direct access connection to fabric attached memory (FAM), which permits storage of datasets in a format conducive to zero-copy analysis, effectively reducing unnecessary data duplication. By utilizing the zero-copy access method, the system directly accesses the dataset within FAM, selectively extracts a batch of data objects to local memory, and executes computation for the distributed workflow predicated on these data objects.

In some examples, the FAM may be CXL compliant memory, offering high-speed interconnection suitable for high-throughput ML tasks within distributed computing frameworks, such as the Ray unified compute framework, among other examples. The ability to utilize a language-independent columnar memory format, such as an Apache Arrow format, ensures zero-copy-enabled data structuring and retrieval. The optimized data extraction process leverages an Apache Arrow record batch stream reader interface with an integrated filter mechanism, thus maintaining data integrity and precision during batch selection.

In this way, the implementations facilitate the conservation of processing resources, memory resources, and network resources. By minimizing redundant data movements to local server memories and avoiding the replication of data across multiple nodes, the system significantly boosts the memory and central processing unit (CPU) efficiency. This advancement translates to an improved scalability for ML workflows on distributed computing frameworks, allowing for augmented data processing capabilities while mitigating the impact on server memory limits. This preventative approach to server performance degradation and the obviated need for incremental hardware expansions underscore the technical and resource-conserving benefits. Hence, these solutions are instrumental in driving the cost-effective advancement of ML computation and large-scale data processing workflows.

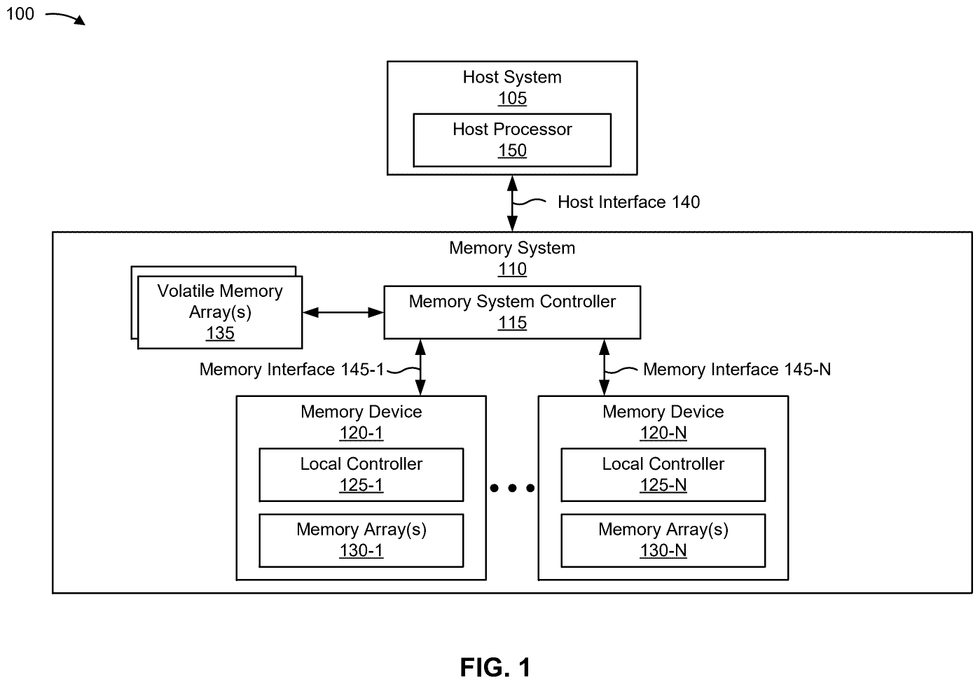

FIG. 1 is a diagram illustrating an example system 100 associated with direct access of a dataset in an FAM for a distributed workflow. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

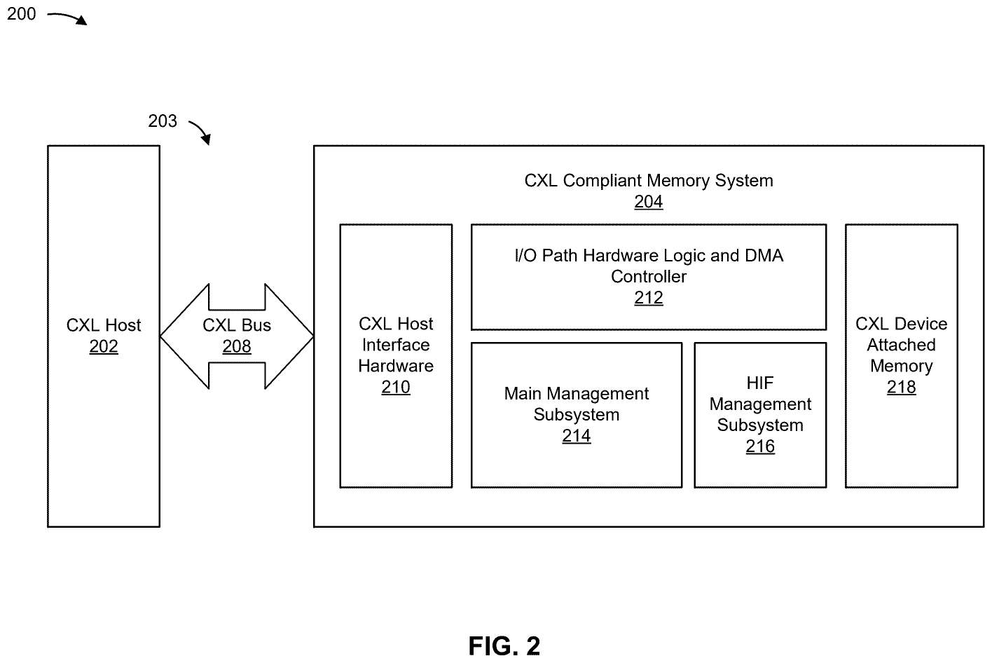

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to store a dataset in a portion of a fabric-attached memory, wherein the dataset is stored in a format that enables analysis of the dataset by multiple host devices associated with a distributed workflow without requiring the multiple host devices to copy the dataset to local memory; and establish a respective direct access connection to the portion of the fabric-attached memory with each host device of the multiple host devices associated with the distributed workflow, wherein the direct access connections enable each host device, of the multiple host devices, to access the dataset via the respective direct access connection and by using an access technique that does not require the host device copy the dataset to a local memory to extract a batch of data objects from the dataset for performing a computation associated with the distributed workflow.

In some implementations, one or more systems, devices, apparatuses, components, and/or controllers of FIG. 1 may be configured to establish a direct access connection to a portion of a fabric-attached memory that stores a dataset associated with a distributed workflow, wherein the dataset is stored in a format that enables zero-copy analysis of the dataset by multiple distributed workflow systems associated with the distributed workflow; access the dataset via the direct access connection and by using a zero-copy access technique; extract a batch of data objects from the dataset by copying the batch of data objects to a local memory associated with the distributed workflow system; and perform a computation associated with the distributed workflow using the batch of data objects.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 associated with direct access of a dataset in an FAM for a distributed workflow. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface, an Ultra Accelerator link (UALink) interface, an Ethernet interface, an ultra Ethernet interface, and/or a similar interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and case of integration into existing systems using the CXL protocol. In some other examples, the CXL bus 208 may be associated with a different type of interface and/or link, such as a UALink, an Ethernet link, an ultra Ethernet link, and/or a similar link. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

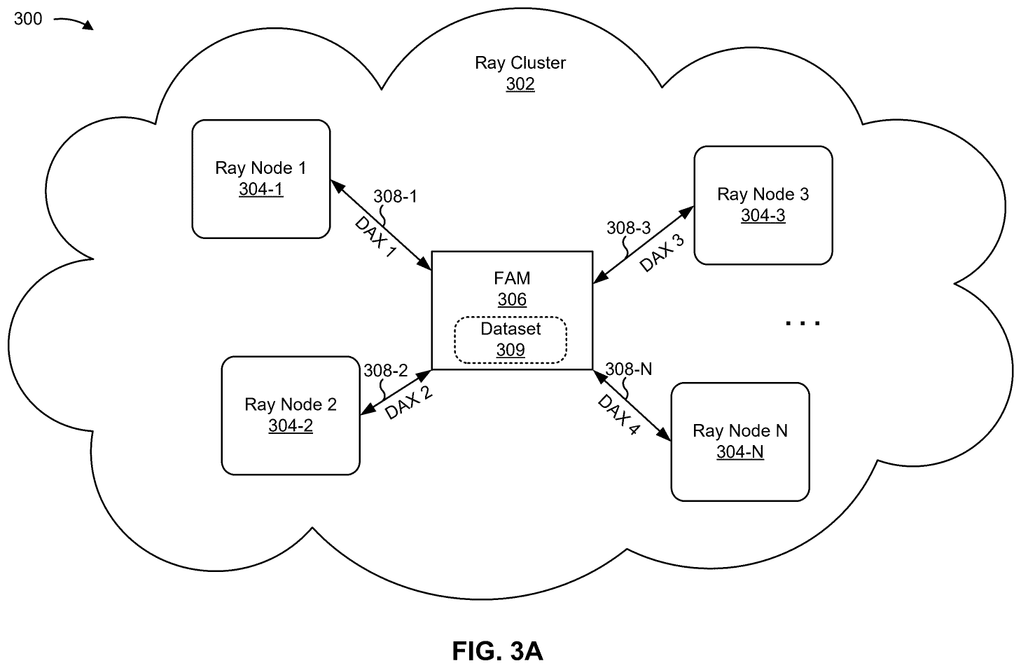

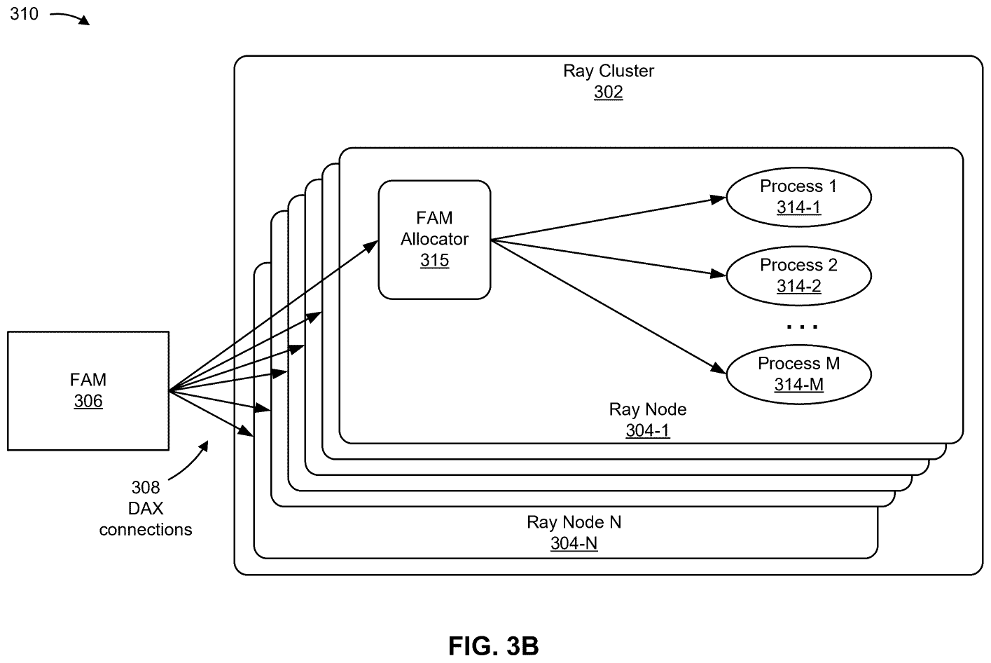

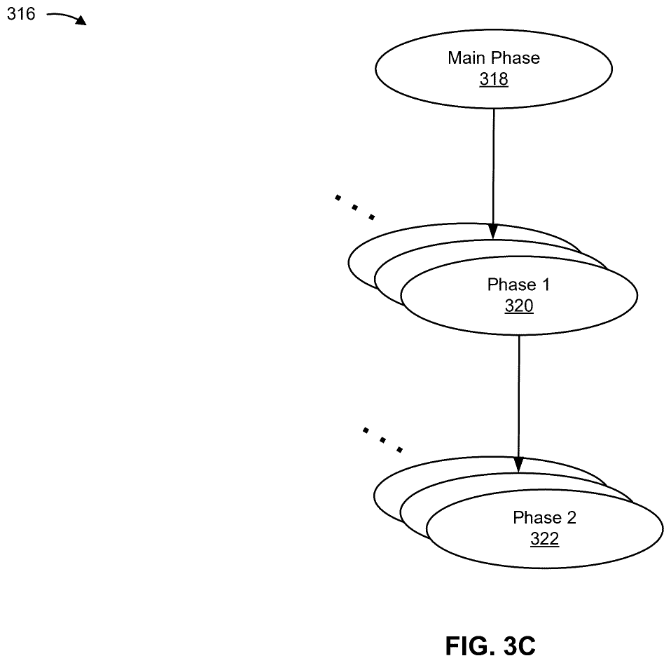

FIGS. 3A-3C are diagrams of examples associated with direct access of a dataset in an FAM for a distributed workflow. The operations described in connection with FIGS. 3A-3C may be performed by the system 100 and/or one or more components of the system 100, such as the host system 105, the host processor 150, the memory system 110, the memory system controller 115, one or more memory devices 120, and/or one or more local controllers 125, and/or the system 200 and/or one or more components of the system 200, such as the CXL host 202, the CXL compliant memory system 204, the main management subsystem 214, and/or the CXL device attached memory 218.

As shown by FIG. 3A, and as indicated by reference number 300, one or more devices may establish one or more direct access connections to a portion of an FAM that stores a dataset associated with a distributed workflow. For example, in implementations associated with a Ray unified compute framework, a Ray cluster 302 may include multiple Ray nodes 304 (shown as a first Ray node 304-1 through an Nth Ray node 304-N) that are in communication with an FAM 306 (e.g., a CXL compliant memory system 204) via respective direct access (DAX) connections 308 (shown as a first DAX connection 308-1 through an Nth DAX connection 308-N). A Ray unified compute framework is a framework that includes a distributed runtime and/or that enables scalability of ML and/or Python workloads. In some implementations, the one or more devices (e.g., the Ray nodes 304) may use protocols compliant with CXL to establish the DAX connections 308 to the FAM 306, which may store a dataset 309 associated with an ML workflow for the Ray unified compute framework (e.g., the Ray cluster 302). Additionally, or alternatively, the dataset 309 may be stored in a format that enables zero-copy analysis of the dataset 309 by multiple distributed workflow systems (e.g., by multiple Ray nodes 304) associated with the distributed workflow. For example, the dataset 309 may be stored using the Apache Arrow format, which is a language-independent columnar memory format for flat and hierarchical data and/or that is organized for efficient analytical operations on modern hardware like CPUs and/or GPUs, thereby allowing efficient analytic operations for the distributed workflow systems without the need for data replication across the systems.

In some aspects, to establish a respective DAX connection 308 to the portion of the FAM 306 storing the dataset 309, a device (e.g., a Ray node 304) may memory map (e.g., using an mmap function associated with a Linux operating system, among other examples) the portion of the FAM 306. Put another way, memory mapping of the FAM 306 may be used by the various Ray nodes 304 to establish a respective DAX connection 308 to the portion of the FAM 306 storing the dataset 309, enabling the distributed workflow systems (e.g., the Ray nodes 304) to treat remote memory (e.g., FAM 306) as if it were local, significantly improving access speed and reducing overhead.

In some implementations, a given Ray node 304 may access the dataset 309 via a respective DAX connection 308 and/or by using a zero-copy access technique. For example, the zero-copy technique may be associated with direct access to the dataset 309 in a non-volatile memory (e.g., the FAM 306) without incurring the latency and overhead of copying the data to volatile memory (e.g., local memory at the given Ray node 304) before processing. This technique may take full advantage of the FAM 306's capabilities, significantly enhancing computation efficiency for the Ray workflows.

In some aspects, a Ray node 304 may extract a batch of data objects (sometimes referred to herein similar as a “batch of data” and/or a “batch of objects”) from the dataset 309 by copying the batch of data objects to a local memory associated with the distributed workflow system (e.g., a local memory associated with the respective Ray node 304). For example, the extracted batch of data objects may correspond to a subset of the larger dataset 309 that is relevant for processing a specific task within the distributed workflow, such as analyzing particular patterns or correlations in ML operations.

To extract the batch of data objects from the dataset 309, the Ray node 304 may utilize an Apache Arrow record batch stream reader interface (sometimes referred to as a RecordBatchStreamReader) with a filter input, among other examples. For example, the Ray node 304 may adopt the RecordBatchStreamReader to efficiently read and filter specific data batches directly from the FAM 306 without necessitating the movement of the entire dataset into the Ray node 304's local memory. Put another way, to extract the batch of data objects from the dataset 309, the Ray node 304 may filter the dataset on the FAM 306 prior to extraction of the batch of data objects. Using filtering operations directly on the FAM 306 may target the extraction process to the precisely needed subsets of data, thereby maximizing efficiency and reducing unnecessary data transfers. In this way, the Ray cluster 302 with FAM 306 may enable offloading of local memory (e.g., local DRAM) traditionally used during data ingest (e.g., data loading) onto the shared FAM 306 (e.g., may enable reduced data movement, or zero-copy data access, using the FAM 306 (e.g., a CXL compliant memory system 204)).

In some aspects, a given Ray node 304 may perform a computation associated with the distributed workflow using the batch of data objects. For example, once the batch is in the local memory, the Ray node 304 may execute a computation, such as training an ML model and/or performing data analytics, using the in-memory data objects, among other examples. Extracting a batch of data objects from the dataset 309 and performing a computation associated with the distributed workflow using the batch of data objects is described in more detail below in connection with FIGS. 3B and 3C.

More particularly, as shown in FIG. 3B, and as indicated by reference number 310, a distributed workflow (e.g., a Ray batch processing ML workflow) may be associated with distributing worker processes (e.g., a distributed unit of computation, sometimes referred to herein simply as a “worker” and/or a “process”) on the Ray cluster 302. For example, in the implementation shown in FIG. 3B, the first Ray node 304-1 may be associated with M processes 314, shown as a first process 314-1 through an M^{th} process 314-M. Similarly, the remaining Ray nodes 304 may be associated with one or more processes 314 (not shown for ease of discussion). In some implementations, a process 314 may be classified as a Phase 1 process or a Phase 2 process, among other examples. “Phase 1 process” may refer to a process that extracts a batch of objects from a larger dataset (e.g., dataset 309) and/or that transforms the batch of objects to suit a subsequent-phase process (e.g., a Phase 2 process). Moreover, “Phase 2 process” may refer to a process that performs a computation on the batch of objects, such as by training a linear regression model using the batch of objects, among other examples. Aspects of Phase 1 processes and Phase 2 processes are described in more detail below in connection with FIG. 3C. Moreover, although Phase 1 processes and Phase 2 processes are described herein, in some other implementations a distributed workflow may include more or fewer phases (e.g., three or more phases) without departing from the scope of the disclosure.

In some implementations, the distributed workflow system (e.g., the Ray cluster 302, the Ray nodes 304, and/or the FAM 306) may be associated with an FAM allocator 315, which may enable access of the FAM 306 and/or the dataset 309 stored thereon by the processes 314. For example, in some implementations, the FAM 306 and/or the dataset 309 stored in the portion of the FAM 306 (e.g., the DAX portion of the FAM 306) may be associated with one large address range. In such aspects, the FAM allocator 315 may enable access of the dataset 309 by the various processes 314, such as by providing a file-system-like interface in which each dataset residing on the FAM 306 may be treated like a file and/or accessed by the processes 314. For example, in some implementations, the FAM allocator 315 may be associated with an FAM file system (FAMFS), in which a memory (e.g., FAM 306) may be exposed and accessed as memory-mappable DAX files and/or which supports multiple hosts (e.g., multiple CXL hosts 202 and/or Ray nodes 304) mounting the same file system from the same memory (e.g., FAM 306).

As shown in FIG. 3C, and as indicated by reference number 316, in some implementations a distributed workflow system may be associated with multiple phases and/or processes (e.g., processes 314). For example, as indicated by reference number 318, before Phase 1 processes and/or Phase 2 processes are dispatched, the distributed workflow system may be associated with a main process. The main process may involve initial data processing tasks, such as parsing datafiles, extracting certain information and lists from the datafiles, and/or creating datasets associated with the datafiles, among other tasks.

By way of an illustrative example, if the distributed workflow system (e.g., the Ray cluster 302) is associated with analyzing a taxicab dataset (which may correspond to the dataset 309) to determine correlations between pickup location and drop-off location pairs and trip durations, the main phase process indicated by reference number 318 may include parsing each datafile associated with the taxicab dataset and/or extracting a list of unique pickup location identifiers (PUIDs) for that datafile; and/or creating, for each PUID, a tuple (e.g., a 2-tuple) with the PUID and the datafile name (sometimes referred to herein as “(PUID, file)”). The main process may then spawn a Phase 1 process for each tuple, indicated by reference number 320. In this regard, the main process indicated by reference number 318 may be associated with creating a list of dataset files; for each file, using a zero-copy format (e.g., an Apache Arrow zero-copy format) to produce a unique PUID list on an FAM (e.g., FAM 306); and/or, for each (PUID, file), calling a Phase 1 process, among other examples.

As described above in connection with FIG. 3B, each Phase 1 process may be associated with a process that extracts a batch of objects from a larger dataset (e.g., dataset 309) and/or that transforms the batch of objects to suit a subsequent-phase process (e.g., a Phase 2 process). For example, returning to the taxicab dataset workflow example described above in connection with the main process, each Phase 1 process may process the PUID and filename tuple (e.g., (PUID, file)) to read the batch of data objects associated with the PUID in the file. “Batch of data objects” refers to a small subset of the dataset file. For example, in the taxicab dataset workflow, the batch of data objects may include drop-off location identifiers (DOIDs), pickup times, and/or drop-off times associated with the given PUID, among other examples. Moreover, as described above in connection with FIGS. 3A and 3B, the Phase 1 process may perform this filtering on an FAM (e.g., FAM 306) using zero-copy techniques, thereby eliminating a need to store the entire dataset (e.g., dataset 309) in local memory (e.g., DRAM) to extract the batch of data.

Additionally, or alternatively, each Phase 1 process may copy the batch of data objects to a local memory (e.g., a data structure associated with Python, such as an in-memory (e.g., CPU) pandas data frame, among other examples) and/or each Phase 1 process may transform the batch of data to suit the Phase 2 process computations (e.g., by applying traditional dataset cleanup procedures, among other examples). In some implementations, the Phase 1 process may perform certain calculations and/or computations associated with the batch of data objects, such as by computing trip durations associated with the batch of data and/or augmenting the computed trip durations to the batch of data (e.g., augmenting the trip durations to the pandas data frame). In some implementations, the Phase 1 process may split the batch of data objects into test and train sets, and/or may spawn a new Phase 2 process and pass the test and train sets to the Phase 2 process, as indicated by reference number 322. In this regard, the Phase 1 processes indicated by reference number 320 may be associated with using a zero-copy filter (e.g., an Apache Arrow zero-copy filter) to generate smaller datasets (e.g., a batch of data objects) for each PUID in the file on the FAM (e.g., FAM 306); copying the smaller dataset in memory and cleaning the smaller dataset; and/or, for each smaller dataset, calling a Phase 2 process, among other examples.

Moreover, and as further described above in connection with FIG. 3B, a Phase 2 process may be associated with a process that performs a computation on the batch of objects, such as by training a linear regression model using the batch of objects, among other examples. For example, returning to the taxicab dataset workflow example described above, each Phase 2 process may use a linear regression model (e.g., a sickit-learn's linear regression model, among other examples) to train the dataset to fit the DOID to trip duration. Additionally, or alternatively, each Phase 2 process may test the model against the test dataset and/or may record the error associated with the model. In some implementations, the Phase 2 process may thus be associated with a pure computation step and/or there may be one Phase 2 worker for every Phase 1 worker. In this regard, the Phase 2 processes indicated by reference number 322 may be associated with performing in-memory compute on the smaller dataset (e.g., the batch of data objects), among other examples. Moreover, as described above, although Phase 1 processes and Phase 2 processes are described herein, in some other implementations a distributed workflow may include more or less phases (e.g., three or more phases) without departing from the scope of the disclosure.

In this way, the integration of FAM (such as a CXL compliant memory system 204) into a distributed workflow system (such as a distributed workflow system associated with a Ray unified compute framework (e.g., Ray cluster 302)) may optimize ML workflows by leveraging zero-copy access techniques and efficient data formats like Apache Arrow, among other examples. Such advancements may enable more efficient scaling, higher throughput, and better resource utilization in modern ML and Al computations. Additionally, or alternatively, the techniques described herein may enable scaling of workflows by expanding memory resource utilization through disaggregation (and thus more efficient computations), may enable using shared FAM (e.g., FAM 306) with zero-copy techniques to avoid consuming local memory, and/or may enable utilizing Apache Arrow or similar existing formats and toolsets for distributed workflows, among other examples.

As indicated above, FIGS. 3A-3C are provided as an example. Other examples may differ from what is described with regard to FIGS. 3A-3C. The number and arrangement of devices shown in FIGS. 3A-3C are provided as an example. In practice, there may be additional devices, fewer devices, different devices, or differently arranged devices than those shown in FIGS. 3A-3C. Additionally, or alternatively, in practice, there may be additional phase processes, fewer phase processes, different phase processes, or differently arranged phase processes than those shown in FIGS. 3A-3C. Furthermore, two or more devices and/or phase processes shown in FIGS. 3A-3C may be implemented within a single device and/or phase process, or a single device and/or phase process shown in FIGS. 3A-3C may be implemented as multiple, distributed devices and/or phase processes. Additionally, or alternatively, a set of devices (e.g., one or more devices) shown in FIGS. 3A-3C may perform one or more functions described as being performed by another set of devices shown in FIGS. 3A-3C.

As indicated above, FIGS. 3A-3B are provided as an example. Other examples may differ from what is described with regard to FIGS. 3A-3B.

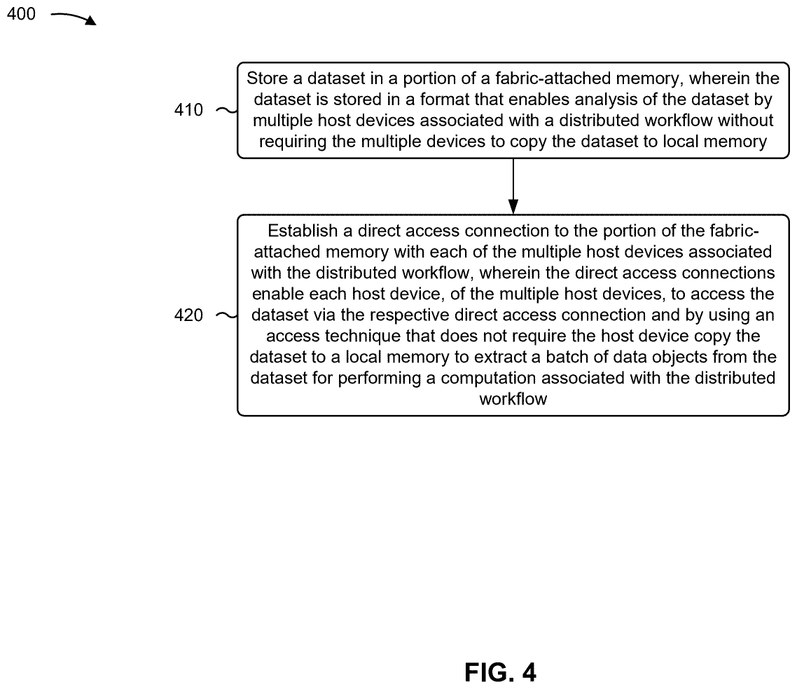

FIG. 4 is a flowchart of an example method 400 associated with direct access of a dataset in an FAM for a distributed workflow. In some implementations, a memory system (e.g., memory system 110, CXL compliant memory system 204, and/or FAM 306) may perform or may be configured to perform the method 400. Additionally, or alternatively, one or more components of the memory system (e.g., memory system controller 115, memory device 120, local controller 125, and/or main management subsystem 214) may perform or may be configured to perform the method 400. Thus, means for performing the method 400 may include the memory system and/or one or more components of the memory system. Additionally, or alternatively, a non-transitory computer-readable medium may store one or more instructions that, when executed by the memory system, cause the memory system to perform the method 400.

As shown in FIG. 4, the method 400 may include storing a dataset in a portion of an FAM, wherein the dataset is stored in a format that enables analysis of the dataset by multiple host devices associated with a distributed workflow without requiring the multiple host devices to copy the dataset to local memory (block 410). For example, the memory system may store the dataset 309 in a portion of the FAM 306 in an Apache Arrow format or a similar format to enable zero-copy analysis of the dataset 309 by multiple Ray nodes 304 associated with the Ray cluster 302, as described above in connection with FIGS. 3A-3C.

As further shown in FIG. 4, the method 400 may include establishing a respective direct access connection to the portion of the FAM with each host device of the multiple host devices associated with the distributed workflow, wherein the direct access connections enable each host device, of the multiple host devices, to access the dataset via the respective direct access connection and by using an access technique that does not require the host device copy the dataset to a local memory to extract a batch of data objects from the dataset for performing a computation associated with the distributed workflow (block 420). For example, the FAM 306 may establish a respective DAX connection 308 with each Ray node 304 of the Ray cluster 302, such that each Ray node 304 of the Ray cluster 302 can access the dataset 309 via a respective DAX connection 308 and/or by using a zero-copy access technique (e.g., a zero-copy access technique associated with an Apache Arrow format, or a similar format) to extract a batch of data objects from the dataset 309 (e.g., so that filtering of the dataset 309 may be performed on the FAM 306 and/or without consuming local memory resources at the respective Ray node 304), as described above in connection with FIGS. 3A-3C.

The method 400 may include additional aspects, such as any single aspect or any combination of aspects described below and/or described in connection with one or more other methods or operations described elsewhere herein.

In a first aspect, the memory system is associated with a CXL compliant memory system. For example, the memory system may be associated with the CXL compliant memory system 204 described above in connection with FIG. 2 and/or the FAM 306 described above in connection with FIGS. 3A-3C.

In a second aspect, alone or in combination with the first aspect, the distributed workflow is associated with a Ray unified compute framework. For example, the distributed workflow may be performed by the Ray nodes 304 of the Ray cluster 302, as described above in connection with FIGS. 3A-3C.

In a third aspect, alone or in combination with one or more of the first and second aspects, the format that enables analysis of the dataset by multiple host devices associated with a distributed workflow without requiring the multiple host devices to copy the dataset to local memory is a language-independent columnar memory format. For example, the format may be an Apache Arrow format or a similar language-independent columnar memory format, as described above in connection with FIGS. 3A-3C.

In a fourth aspect, alone or in combination with one or more of the first through third aspects, the format that enables analysis of the dataset by multiple host devices associated with a distributed workflow without requiring the multiple host devices to copy the dataset to local memory is an Apache Arrow format. For example, the format may be the Apache Arrow format, as described above in connection with FIGS. 3A-3C.

In a fifth aspect, alone or in combination with one or more of the first through fourth aspects, the distributed workflow is associated with machine learning operations. For example, the distributed workflow may be associated with performing ML computations in a similar manner as described above in connection with the taxicab dataset distributed workflow.

In a sixth aspect, alone or in combination with one or more of the first through fifth aspects, establishing the respective direct access connection to the portion of the FAM with each host device of multiple host devices comprises enabling each host device, of the multiple host devices, to memory map the portion of the fabric-attached memory. For example, the FAM 306 may enable each Ray node 304 of the Ray cluster 302 to establish a respective DAX connection 308 to the FAM 306 by using an mmap command to memory map the portion of the FAM 306 that stores the dataset 309, as described above in connection with FIGS. 3A-3C.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

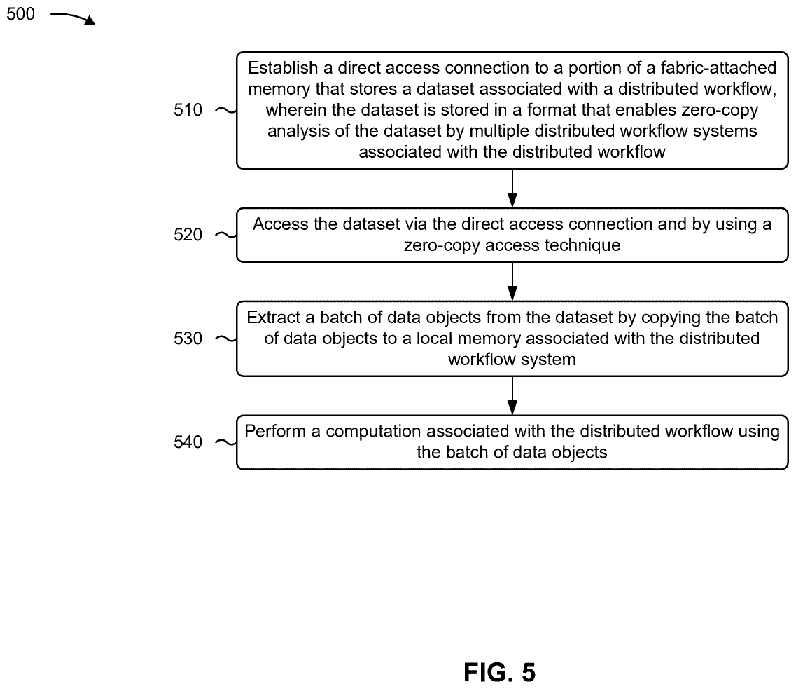

FIG. 5 is a flowchart of an example method 500 associated with direct access of a dataset in a fabric-attached memory for a distributed workflow. In some implementations, a distributed workflow system (e.g., the Ray cluster 302) may perform or may be configured to perform the method 500. Additionally, or alternatively, one or more components of the distributed workflow system (e.g., one or more Ray nodes 304, the FAM 306, and/or the FAM allocator 315) may perform or may be configured to perform the method 500. Thus, means for performing the method 500 may include the distributed workflow system and/or one or more components of the distributed workflow system. Additionally, or alternatively, a non-transitory computer-readable medium may store one or more instructions that, when executed by the distributed workflow system, cause the distributed workflow system to perform the method 500.

As shown in FIG. 5, the method 500 may include establishing a direct access connection to a portion of an FAM that stores a dataset associated with a distributed workflow, wherein the dataset is stored in a format that enables zero-copy analysis of the dataset by multiple distributed workflow systems associated with the distributed workflow (block 510). For example, each Ray node 304 of the Ray cluster 302 may establish a respective DAX connection 308 with a portion of the FAM 306 that stores the dataset 309, with the dataset 309 being stored in a format that enables zero-copy analysis of the dataset 309 by the multiple Ray nodes 304, as described above in connection with FIGS. 3A-3C.

As further shown in FIG. 5, the method 500 may include accessing the dataset via the direct access connection and by using a zero-copy access technique (block 520). For example, each Ray node 304 may access the dataset 309 and/or perform filtering thereon using a zero-copy access technique (e.g., such that the entire dataset 309 is not copied to a local memory associated with that Ray node 304), as described above in connection with FIGS. 3A-3C.

As further shown in FIG. 5, the method 500 may include extracting a batch of data objects from the dataset by copying the batch of data objects to a local memory associated with the distributed workflow system (block 530). For example, each Ray node 304 (e.g., a Phase 1 worker of each Ray node 304) may extract a batch of data objects from the dataset 309 by copying the batch of data objects to a local memory associated with that Ray node 304, as described above in connection with FIGS. 3A-3C.

As further shown in FIG. 5, the method 500 may include performing a computation associated with the distributed workflow using the batch of data objects (block 540). For example, each Ray node 304 (e.g., a Phase 2 worker of each Ray node 304) may perform a computation (e.g., a linear regression analysis, among other examples) associated with the distributed workflow using the batch of data objects that is stored in local memory, as described above in connection with FIGS. 3A-3C.

The method 500 may include additional aspects, such as any single aspect or any combination of aspects described below and/or described in connection with one or more other methods or operations described elsewhere herein.

In a first aspect, the FAM is associated with a compute express link compliant memory. For example, the FAM 306 may be associated with the CXL compliant memory system 204 described above in connection with FIG. 2.

In a second aspect, alone or in combination with the first aspect, the distributed workflow is associated with a Ray unified compute framework. For example, the distributed workflow may be performed by the Ray nodes 304 of the Ray cluster 302, as described above in connection with FIGS. 3A-3C.

In a third aspect, alone or in combination with one or more of the first and second aspects, the format that enables zero-copy analysis of the dataset is a language-independent columnar memory format. For example, the format that enables zero-copy analysis of the dataset 309 may be an Apache Arrow format or a similar language-independent columnar memory format, as described above in connection with FIGS. 3A-3C.

In a fourth aspect, alone or in combination with one or more of the first through third aspects, the format that enables zero-copy analysis of the dataset is an Apache Arrow format. For example, the format that enables zero-copy analysis of the dataset 309 may be the Apache Arrow format, as described above in connection with FIGS. 3A-3C.

In a fifth aspect, alone or in combination with one or more of the first through fourth aspects, extracting the batch of data objects from the dataset comprises an Apache Arrow record batch stream reader interface with a filter input. For example, each Ray node 304 may use an Apache Arrow record batch stream reader interface (e.g., RecordBatchStreamReader) with a filter input to extract the batch of data objects, as described above in connection with FIGS. 3A-3C.

In a sixth aspect, alone or in combination with one or more of the first through fifth aspects, the distributed workflow is associated with ML operations. For example, the distributed workflow may be associated with performing ML computations in a similar manner as described above in connection with the taxicab dataset distributed workflow.

In a seventh aspect, alone or in combination with one or more of the first through sixth aspects, establishing the direct access connection to the portion of the FAM comprises memory mapping the portion of the fabric-attached memory. For example, each Ray node 304 of the Ray cluster 302 may establish a respective DAX connection 308 to the FAM 306 by using an mmap command to memory map the portion of the FAM 306 that stores the dataset 309, as described above in connection with FIGS. 3A-3C.

In an eighth aspect, alone or in combination with one or more of the first through seventh aspects, extracting the batch of data objects from the dataset comprises filtering the dataset on the FAM prior to extraction of the batch of data objects. For example, a Phase 1 worker of a Ray node 304 may extract a batch of data objects from the dataset 309 by filtering the dataset 309 on the FAM 306 prior to extraction of batch of data objects, thus avoiding copying of the entire dataset 309 into local memory, as described above in connection with FIGS. 3A-3C.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, a memory system includes one or more components configured to: store a dataset in a portion of a fabric-attached memory, wherein the dataset is stored in a format that enables analysis of the dataset by multiple host devices associated with a distributed workflow without requiring the multiple host devices to copy the dataset to local memory; and establish a respective direct access connection to the portion of the fabric-attached memory with each host device of the multiple host devices associated with the distributed workflow, wherein the direct access connections enable each host device, of the multiple host devices, to access the dataset via the respective direct access connection and by using an access technique that does not require the host device copy the dataset to a local memory to extract a batch of data objects from the dataset for performing a computation associated with the distributed workflow.

In some implementations, a distributed workflow system includes one or more components configured to: establish a direct access connection to a portion of a fabric-attached memory that stores a dataset associated with a distributed workflow, wherein the dataset is stored in a format that enables zero-copy analysis of the dataset by multiple distributed workflow systems associated with the distributed workflow; access the dataset via the direct access connection and by using a zero-copy access technique; extract a batch of data objects from the dataset by copying the batch of data objects to a local memory associated with the distributed workflow system; and perform a computation associated with the distributed workflow using the batch of data objects.

In some implementations, a method includes storing, by a memory system, a dataset in a portion of a fabric-attached memory, wherein the dataset is stored in a format that enables analysis of the dataset by multiple host devices associated with a distributed workflow without requiring the multiple host devices to copy the dataset to local memory; and establishing, by the memory system, a respective direct access connection to the portion of the fabric-attached memory with each host device of the multiple host devices associated with the distributed workflow, wherein the direct access connections enable each host device, of the multiple host devices, to access the dataset via the respective direct access connection and by using an access technique that does not require the host device copy the dataset to a local memory to extract a batch of data objects from the dataset for performing a computation associated with the distributed workflow.

In some implementations, a method includes establishing, by a distributed workflow system, a direct access connection to a portion of a fabric-attached memory that stores a dataset associated with a distributed workflow, wherein the dataset is stored in a format that enables zero-copy analysis of the dataset by multiple distributed workflow systems associated with the distributed workflow; accessing, by the distributed workflow system, the dataset via the direct access connection and by using a zero-copy access technique; extracting, by the distributed workflow system, a batch of data objects from the dataset by copying the batch of data objects to a local memory associated with the distributed workflow system; and performing, by the distributed workflow system, a computation associated with the distributed workflow using the batch of data objects.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a +b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
store a dataset in a portion of a fabric-attached memory,
wherein the dataset is stored in a format that enables analysis of the dataset by multiple host devices associated with a distributed workflow without requiring the multiple host devices to copy the dataset to local memory; and
establish a respective direct access connection to the portion of the fabric-attached memory with each host device of the multiple host devices associated with the distributed workflow,
wherein the direct access connections enable each host device, of the multiple host devices, to access the dataset via the respective direct access connection and by using an access technique that does not require the host device copy the dataset to a local memory to extract a batch of data objects from the dataset for performing a computation associated with the distributed workflow.

2. The memory system of claim 1, wherein the memory system is associated with a compute express link compliant memory system.

3. The memory system of claim 1, wherein the distributed workflow is associated with a Ray unified compute framework.

4. The memory system of claim 1, wherein the format that enables analysis of the dataset by multiple host devices associated with a distributed workflow without requiring the multiple host devices to copy the dataset to local memory is a language-independent columnar memory format.

5. The memory system of claim 1, wherein the format that enables analysis of the dataset by multiple host devices associated with a distributed workflow without requiring the multiple host devices to copy the dataset to local memory is an Apache Arrow format.

6. The memory system of claim 1, wherein the distributed workflow is associated with machine learning operations.

7. The memory system of claim 1, wherein the one or more components, to establish the respective direct access connection to the portion of the fabric-attached memory with each host device of the multiple host devices, are configured to enable each host device, of the multiple host devices, to memory map the portion of the fabric-attached memory.

8. A distributed workflow system, comprising:
one or more components configured to:
establish a direct access connection to a portion of a fabric-attached memory that stores a dataset associated with a distributed workflow,
wherein the dataset is stored in a format that enables zero-copy analysis of the dataset by multiple distributed workflow systems associated with the distributed workflow;
access the dataset via the direct access connection and by using a zero-copy access technique;
extract a batch of data objects from the dataset by copying the batch of data objects to a local memory associated with the distributed workflow system; and
perform a computation associated with the distributed workflow using the batch of data objects.

9. The distributed workflow system of claim 8, wherein the fabric-attached memory is associated with a compute express link compliant memory.

10. The distributed workflow system of claim 8, wherein the distributed workflow is associated with a Ray unified compute framework.

11. The distributed workflow system of claim 8, wherein the format that enables zero-copy analysis of the dataset is a language-independent columnar memory format.

12. The distributed workflow system of claim 8, wherein the format that enables zero-copy analysis of the dataset is an Apache Arrow format.

13. The distributed workflow system of claim 12, wherein the one or more components, to extract the batch of data objects from the dataset, are configured to use an Apache Arrow record batch stream reader interface with a filter input.

14. The distributed workflow system of claim 8, wherein the distributed workflow is associated with machine learning operations.

15. The distributed workflow system of claim 8, wherein the one or more components, to establish the direct access connection to the portion of the fabric-attached memory, are configured to memory map the portion of the fabric-attached memory.

16. The distributed workflow system of claim 8, wherein the one or more components, to extract the batch of data objects from the dataset, are configured to filter the dataset on the fabric-attached memory prior to extraction of the batch of data objects.

17. A method, comprising:
storing, by a memory system, a dataset in a portion of a fabric-attached memory,
wherein the dataset is stored in a format that enables analysis of the dataset by multiple host devices associated with a distributed workflow without requiring the multiple host devices to copy the dataset to local memory; and
establishing, by the memory system, a respective direct access connection to the portion of the fabric-attached memory with each host device of the multiple host devices associated with the distributed workflow,
wherein the direct access connections enable each host device, of the multiple host devices, to access the dataset via the respective direct access connection and by using an access technique that does not require the host device copy the dataset to a local memory to extract a batch of data objects from the dataset for performing a computation associated with the distributed workflow.

18. The method of claim 17, wherein the memory system is associated with a compute express link compliant memory system.

19. The method of claim 17, wherein the distributed workflow is associated with a Ray unified compute framework.

20. The method of claim 17, wherein the format that enables analysis of the dataset by multiple host devices associated with a distributed workflow without requiring the multiple host devices to copy the dataset to local memory is a language-independent columnar memory format.

21. The method of claim 17, wherein the format that enables analysis of the dataset by multiple host devices associated with a distributed workflow without requiring the multiple host devices to copy the dataset to local memory is an Apache Arrow format.

22. The method of claim 17, wherein the distributed workflow is associated with machine learning operations.

23. The method of claim 17, wherein establishing the respective direct access connection to the portion of the fabric-attached memory with each host device of multiple host devices comprises enabling each host device, of the multiple host devices, to memory map the portion of the fabric-attached memory.

24. A method, comprising:
establishing, by a distributed workflow system, a direct access connection to a portion of a fabric-attached memory that stores a dataset associated with a distributed workflow,
wherein the dataset is stored in a format that enables zero-copy analysis of the dataset by multiple distributed workflow systems associated with the distributed workflow;
accessing, by the distributed workflow system, the dataset via the direct access connection and by using a zero-copy access technique;
extracting, by the distributed workflow system, a batch of data objects from the dataset by copying the batch of data objects to a local memory associated with the distributed workflow system; and
performing, by the distributed workflow system, a computation associated with the distributed workflow using the batch of data objects.

25. The method of claim 24, wherein the fabric-attached memory is associated with a compute express link compliant memory.
